(19) United States
(12) Patent Application Publication
(10) Pub. No.: US 2008/0077369 A1
(43) Pub. Date: Mar. 27, 2008

(54) Apparatus and method for simulating a mold cooling process for injection molding

(75) Inventors: Rong-Yeu Chang, Hsinchu City (TW); Yu-Feng Chen, Hsinchu City (TW); Wen-Hsien Yang, Hsinchu City (TW); Cheng-Yung Liu, Hsinchu City (TW); Yi-Hui Peng, Hsinchu City (TW); Chia-Hsiang Hsu, Hsinchu City (TW)

Correspondence Address: BACON & THOMAS, PLLC, 625 SLATERS LANE, FOURTH FLOOR, ALEXANDRIA, VA, 22314, US

(73) Assignee: CoreTech System Co., Ltd, Hsinchu City (TW)

(21) Appl. No.: 11/525,824

(22) Filed: Sep. 25, 2006

(51) Int. Cl. G06G 7/48

(52) U.S. Cl. 703/6

(57) ABSTRACT

The invention provides an apparatus and method for simulating a mold cooling process for injection molding. The mold includes a moldbase and a cavity; the method comprises the steps of creating a plurality of cavity meshes for the cavity, automatically creating a plurality of uniform or adaptive moldbase meshes for the moldbase, and determining the relationship between the cavity meshes and the moldbase meshes. Based on the relationship, a numerical method is applied to calculate the temperature distributions of the cavity and moldbase in the mold cooling process.

### BACKGROUND OF THE INVENTION

1. Field of the Invention

The present invention relates to an apparatus and method for simulating a mold cooling process for injection molding, and more particularly, to a method for automatically creating a plurality of uniform or adaptive moldbase meshes for a moldbase, and determining their relationship between a plurality of cavity meshes and the plurality of the moldbase meshes. Then, based on the relationship, a numerical method is utilized to calculate the temperature distribution of the cavity and moldbase in the mold cooling process.

2. Description of the Related Art

Generally, in the field of computer aided engineering analysis, various numerical analysis methods, such as FDM, FEM, FVM or BEM, must perform a computer mesh division of the object model that will be simulated.

Please refer to FIG. 1. FIG. 1 is a schematic drawing of a prior art mold. As shown in FIG. 1, a mold 1 has a moldbase 11, a cavity 12 and water conduits 13a, 13b, 13c and 13d, etc. Therefore, for a mold of flow analysis of the mold 1, the moldbase 11, the cavity 12 and the water conduits 13a, 13b, 13c and 13d, etc. must all be simulated utilizing the computer mesh division process. For a three-dimensional model, a three-dimensional computer mesh division process needs to be performed for the analysis.

Please refer to FIG. 2. FIG. 2 is a schematic drawing of a mesh system of the prior art mold. As shown in FIG. 2, since the cavity 12 and the moldbase 11 are connected, the meshes for moldbase mesh system 110 created by the prior art technology are created manually based on the meshes of a cavity mesh system 120. However, the accuracy of the mesh system for the moldbase 11 is not required to be as high as the mesh system for the cavity 12, and so the prior art technology wastes resources and calculation time on unnecessary meshes for the moldbase 11. For information concerning the prior art mesh creation method, please refer to Rong-Yeu Chang, Wen-Hsien Yang, David C. Hsu & Venny Yang, Three-Dimensional Computer-Aided Mold Cooling Design for Injection molding, SPE ANTEC TECH. PAPER, 656-60 (2003).

Another prior art technology provides a boundary element method for performing the cooling analysis of the mold. However, this method assumes that the moldbase boundary is infinitely far away to reduce the three dimensional moldbase into a two dimensional system for subsequent analysis, rather than performing a real, three dimensional analysis. For further information concerning this method see L. S. Turng & K. K. Wang, A Computer-Aided Cooling-Line Design System for Injection Molds, 112 JOURNAL OF ENGINEERNG FOR INDUSTRY 161-67 (1990); T. H. Kwon, Mold Cooling System Design Using Boundary Element Method, 110:4 J. ENG. IND. (TRANS. ASME) 384-94 (1988).

Therefore, it is desirable to provide an apparatus and method for simulating a mold cooling process for injection molding to mitigate and/or obviate the aforementioned problems.

### SUMMARY OF THE INVENTION

The present invention provides an apparatus and method for simulating a three dimensional mold cooling process for CAE analysis of injection molding.

The method of the present invention comprises:
(1) creating a cavity mesh system with a plurality of cavity meshes;
(2) automatically creating a plurality of uniform or adaptive moldbase meshes for the moldbase;
(3) finding each cavity boundary mesh and each moldbase boundary mesh at the boundary between the cavity mesh system and the moldbase mesh system;
(4) defining a relationship between each moldbase boundary mesh and each cavity boundary mesh; and
(5) according to this relationship, applying a numerical method to the mold for a cooling analysis.

The present invention can automatically create an independent, three dimensional moldbase solid mesh system for a real three dimensional flow analysis of the mold. With this method, the user does not need to spend a lot of time to build the moldbase mesh system, and can quickly obtain a cooling analysis results for the mold.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a prior art mold.

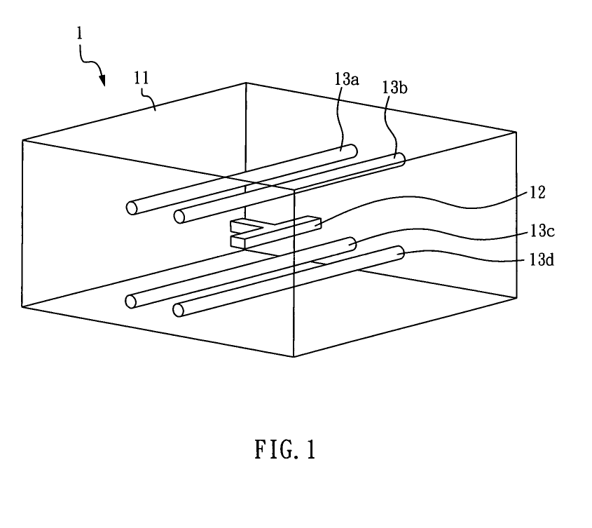

FIG. 2 is a schematic drawing of a mesh system of the prior art mold.

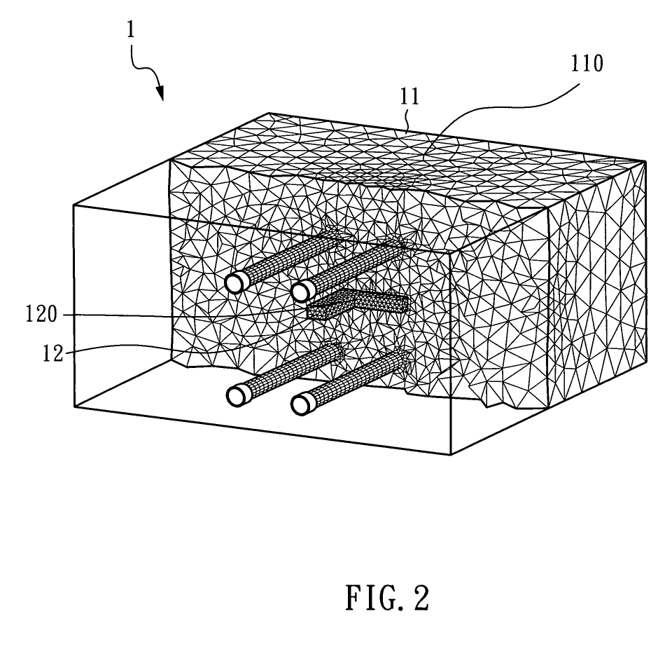

FIG. 3 is a schematic drawing of a cavity mesh system according to the present invention.

FIG. 4 is a schematic drawing of a uniform moldbase mesh system according to the present invention.

FIG. 5 is a schematic drawing of a self-adaptive moldbase mesh system according to the present invention.

FIG. 6 shows boundaries of a cavity mesh system and a moldbase mesh system according to the present invention.

FIG. 7 shows ignored nodes of a moldbase boundary mesh according to the present invention.

FIG. 8 shows the calculation of a relative relationship between a cavity mesh system and a moldbase mesh system according to the present invention.

FIG. 9 is a flowchart of a method for simulating a mold cooling process for injection molding according to the present invention.

### DETAILED DESCRIPTION OF THE PREFERRED EMBODIMENT

The present invention provides an apparatus and methods for simulating a mold cooling analysis for injection molding, which comprises automatically creating an independent, three dimensional moldbase solid mesh system for a real three dimensional flow analysis of the mold. With this method, the user does not need to spend a lot of time to build the mesh system, and can quickly obtain a cooling analysis results for the mold (which includes the cavity, the flow path, the moldbase, the cooling conduit, the heating rod, and various other elements).

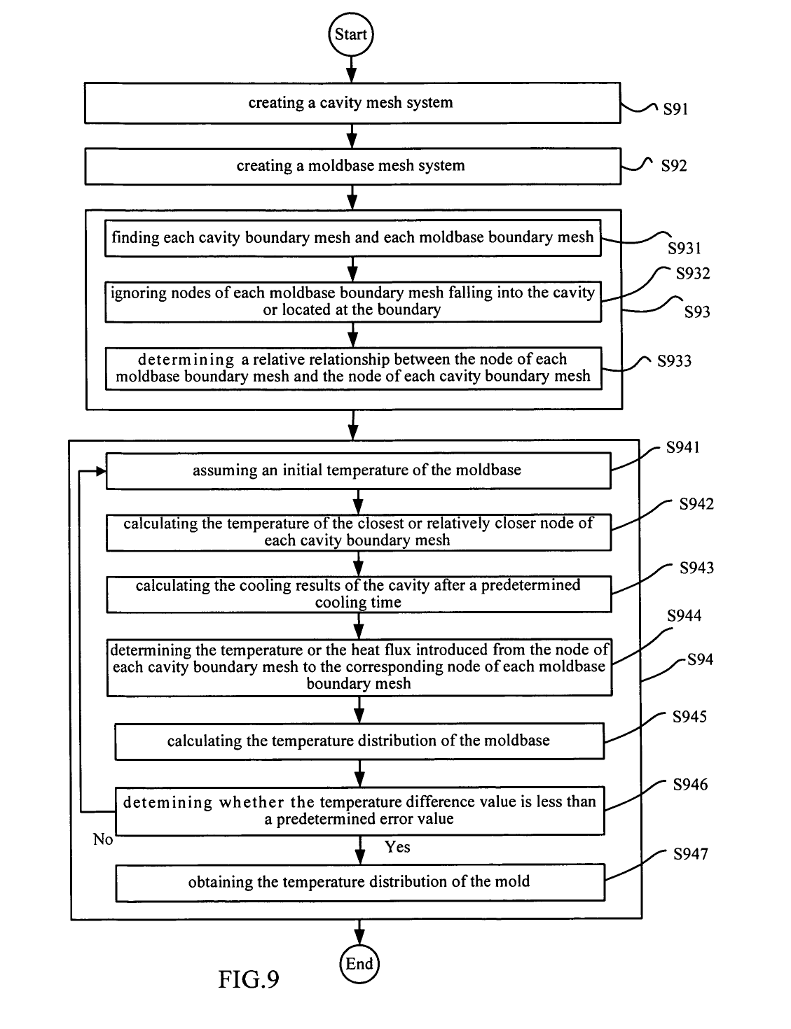

Please refer to FIG. 9. FIG. 9 is a flowchart of a method for simulating the mold cooling process for injection molding according to the present invention. As shown in FIG. 9, the method of the present invention comprises steps S91, S92, S93 and S94.

In step S91, a cavity mesh system for simulating the geometrical shape of the cavity of a mold is created to obtain the geometrical shape of the cavity. In an embodiment of the present invention, the cavity mesh system is created with CAD modeling, or through a triangle mesh stereolithography (STL) file. Since CAD modeling and triangle mesh stereolithography (STL) files are well known technologies used for meshing, they will not be further explained in this application.

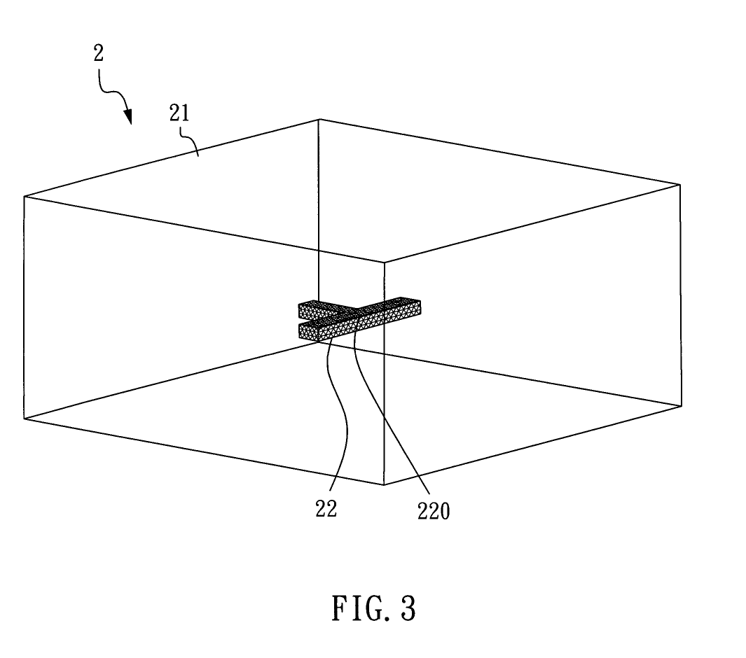

Please refer to FIG. 3. After step S91, a cavity mesh system 220 is created. As shown in FIG. 3, the cavity mesh system 220 having a plurality of meshes to obtain the geometrical shape of the cavity 22 for further analysis.

In one embodiment of the present invention, the mold 2 has a flow path, a moldbase, a cooling conduit, a heating rod and certain other elements, which can be treated as the cavity 22. Furthermore, in one embodiment of the present invention, the cavity 22 can be a shell model cavity, but the invention is not limited to such an embodiment.

Next, in step S92, a moldbase mesh system is created for simulating the geometrical shape of the moldbase to obtain the geometrical shape of the moldbase.

In step S92, the moldbase mesh system is automatically created based on the geometrical shape of the cavity 22 and independently from the cavity mesh system 220 in step 91; unlike the prior art technology, where the moldbase mesh system is created based on the cavity mesh system 220. Therefore, with the present invention, the user does not need to use the mesh generator to manually create the moldbase mesh system. Meanwhile, the moldbase mesh system of the present invention is independent of the cavity mesh system 220; therefore, there is no need to generate a large moldbase mesh system based on the cavity mesh system. The present invention is particularly suitable for a thin cavity 22 or for cavities 22 with complicated shapes. When the cavity 22 is thin, the number of meshes for the moldbase mesh system in the present invention will be significantly fewer than the number of meshes in the prior art technology, which can increase calculation efficiencies.

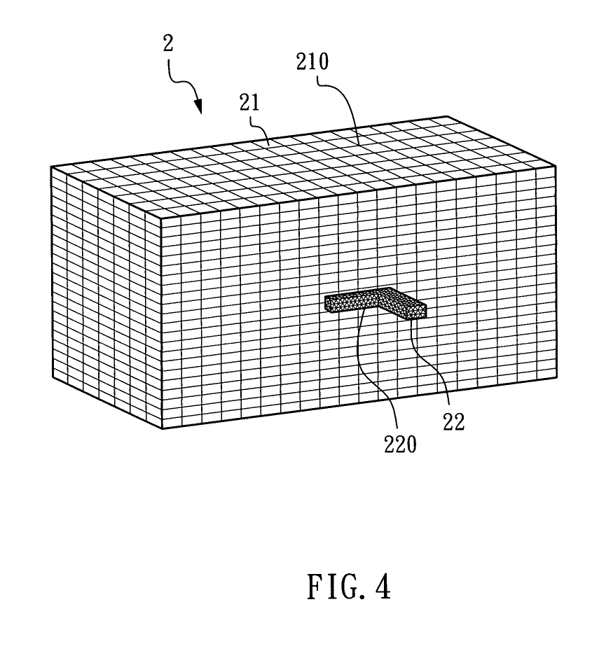

Please refer to FIG. 4. FIG. 4 is a schematic drawing of a uniform moldbase mesh system according to the present invention. As shown in FIG. 4, after step S92, a moldbase mesh system 210 with a plurality of meshes can be created for the moldbase 21 of the mold 2, to obtain the geometrical shape characteristics of the moldbase 21 for subsequent analysis.

In step S92, the moldbase mesh system 210 has a plurality of solid meshes for a real three dimensional mold cooling analysis.

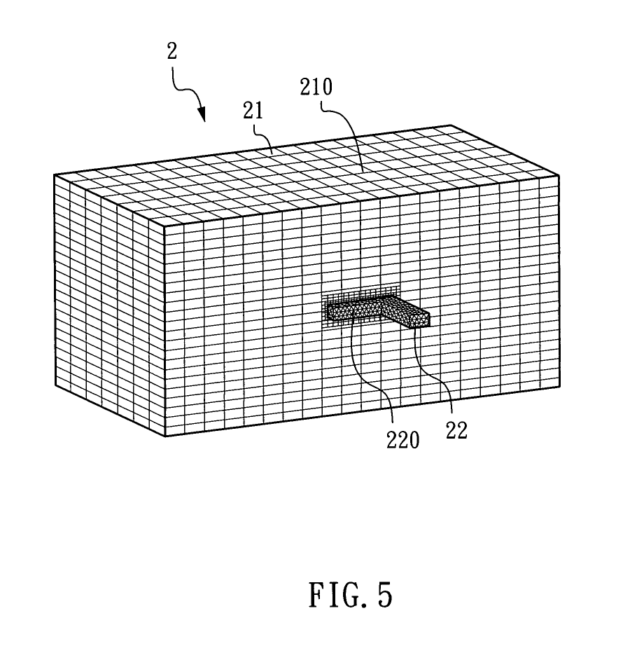

Moreover, in step S92, as shown in FIG. 4, a uniform moldbase mesh system 210 can be created; or as shown in FIG. 5, an adaptive moldbase mesh system 210 can be automatically created, which has higher mesh density near the cavity 22 for a better analysis. Since the adaptive mesh creation technology is a well known technology, it requires no further description.

As shown in FIG. 9, after step S91 and S92, the cavity mesh system 220 and the moldbase mesh system 210 are created; in step S93, a relative relationship between the cavity mesh system 220 and the moldbase mesh system 210 is determined, which can be utilized for calculating heat transfer to obtain the cooling analysis results of the mold 2.

As shown in FIG. 9, in one embodiment of the present invention, step S93 further comprises steps S931, S932 and S933, which will be explained in the following.

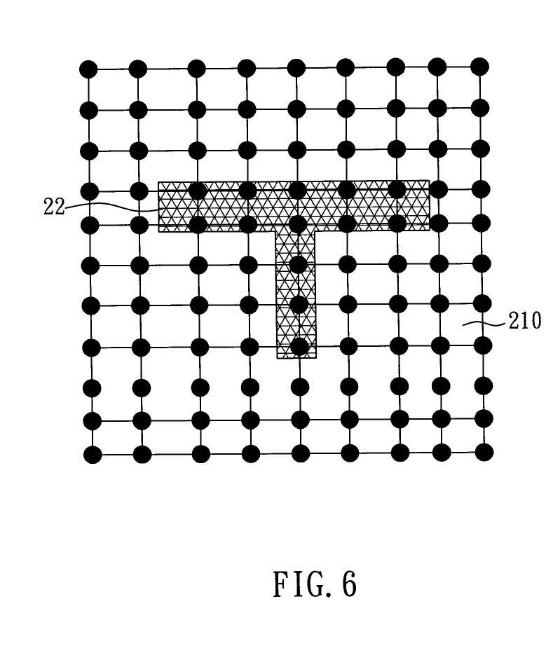

First, in step S931, each cavity boundary mesh and each moldbase boundary mesh at the cavity mesh system 220 and the moldbase mesh system 210 is defined. Since the moldbase mesh system 210 is automatically generated and independent of the cavity mesh system 220, as shown in FIG. 6, some moldbase meshes 210 may fall into the cavity 22 or be located at the boundary of the cavity 22. Therefore, in step S93, each cavity boundary mesh and each moldbase boundary mesh is defined for further analysis.

Next, in step S932, each node of each moldbase boundary mesh falling into the cavity 22 or located at the boundary of the cavity 22 is ignored, to form independent and non-overlapped cavity mesh system 220 and moldbase mesh system 210.

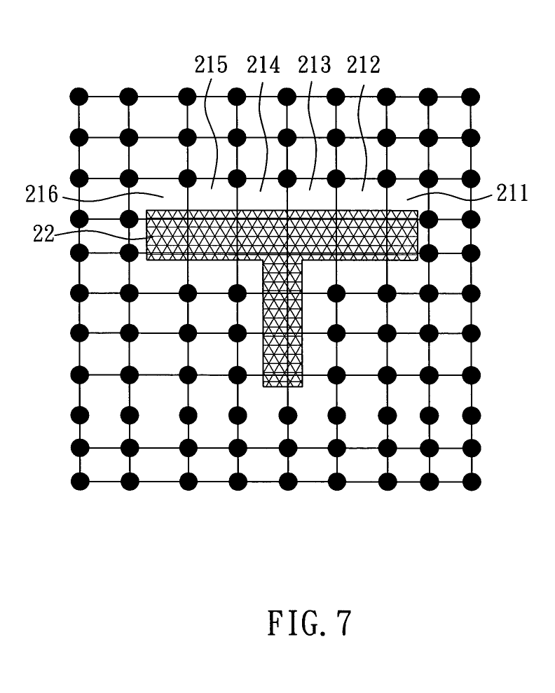

Please refer to FIG. 7. FIG. 7 is a schematic drawing of the ignored nodes of the moldbase boundary mesh according to the present invention. As shown in FIG. 7, each node of each moldbase boundary mesh, such as meshes 211, 212, 213, 214, 215 and 216 falls into the cavity 22 or is located at the boundary of the cavity 22, and so is ignored; independent cavity mesh system 220 and moldbase mesh system 210 are thus created.

Next, in step S933, a relative relationship between each node of each moldbase boundary mesh and each node of each cavity boundary mesh of the cavity mesh system 220 and the moldbase mesh system 210 is determined, and a numerical method can be utilized to perform the cooling analysis for the mold 2 based on this relative relationship. In step S933, a relative distance between each node of each cavity boundary mesh and each node of each moldbase boundary mesh is calculated, and the relative relationship between each node of each moldbase boundary mesh and each node of each cavity boundary mesh is defined based on the relative distance. For example, in step S933, the closest node or the relatively closer nodes of the cavity boundary mesh for nodes of the moldbase boundary mesh can be obtained. Similarly, the closest node or relatively closer nodes of the moldbase boundary mesh for nodes of the cavity boundary mesh can also be obtained.

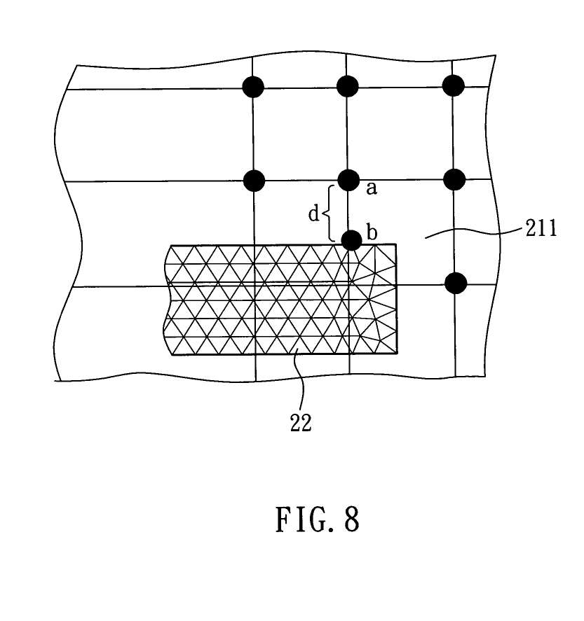

As shown in FIG. 8, by calculating a distance “d” between the node “a” of each moldbase boundary mesh (such as the mesh 211) and the node “b” of the cavity boundary mesh, the relative relationship between the node of each moldbase boundary mesh and the node of each cavity boundary mesh is obtained.

Finally, after step S93, the relative relationship between the cavity mesh system 210 and the moldbase mesh system 220 is obtained; in step S94, a numerical method can be utilized to perform the cooling analysis for the mold 2 based on the relative relationship.

As shown in FIG. 9, in one embodiment of the present invention, step S94 further comprises steps S941, S942, S943, S944, S945, S946 and S947, which are explained in the following.

First, in step S941, an initial temperature of the moldbase is assumed (in other words, the initial temperature of the node of each moldbase boundary mesh is determined).

In step S942, the relative relationship obtained from step S93 is used to calculate the temperature or the heat flux of the closest or relatively closer nodes of each cavity boundary mesh based on the initial temperature of the nodes of each moldbase boundary mesh.

In step S943, the temperature or the heat flux of the node of each cavity boundary mesh are used as boundary conditions to calculate the cooling results of the cavity 22 after a predetermined cooling time.

Next, in step S944, according to the cooling results and the relative relationship obtained in step S93, the temperature or the heat flux introduced from the node of each cavity boundary mesh to the corresponding node of each moldbase boundary mesh is determined.

In step S945, the temperature or the heat flux is used as a boundary condition to calculate the temperature distribution of the moldbase 21 and to obtain a new temperature of the node for each moldbase boundary mesh.

Then, in step S946, according to the new temperature, a temperature difference value between the node of each moldbase boundary mesh and the corresponding node of each cavity boundary mesh is determined if it is less than a predetermined error value. If the temperature difference is not less than the predetermined error value, then based on the new temperature, step S941 to step S945 are repeatedly performed until the temperature difference value is less than the predetermined error value. The temperature distribution of the mold provides the three dimensional cooling analysis results for the mold obtained in step S947.

Although the present invention has been explained in relation to its preferred embodiment, it is to be understood that many other possible modifications and variations can be made without departing from the spirit and scope of the invention as hereinafter claimed.

What is claimed is:

1. A method for simulating a mold cooling process for injection molding, the mold including a moldbase and a cavity, the method comprising:
(a) creating a cavity mesh system with a plurality of cavity meshes;
(b) automatically creating a moldbase mesh system with a plurality of moldbase meshes;
(c) determining a relationship between the cavity mesh system and the moldbase mesh system; and
(d) according to the relationship, applying a numerical method to the mold for a cooling analysis.

2. The method as claimed in claim 1, wherein in step (a), a CAD model or a triangle mesh stereolithography (STL) file is utilized to generate a three-dimensional shell model mesh system of the cavity.

3. The method as claimed in claim 1, wherein in step (a), a CAD model or a triangle mesh stereolithography (STL) file is utilized to generate a three-dimensional solid mesh system of the cavity.

4. The method as claimed in claim 1, wherein in step (b), the moldbase mesh system is created independently of the cavity mesh system.

5. The method as claimed in claim 1, wherein in step (b) the moldbase mesh system is automatically created according to a geometrical shape of the cavity.

6. The method as claimed in claim 1, wherein in step (b), the plurality of moldbase meshes are a plurality of solid meshes.

7. The method as claimed in claim 1, wherein in step (b), a uniform moldbase mesh system is automatically created.

8. The method as claimed in claim 1, wherein in step (b), an adaptive moldbase mesh system is automatically created, and a plurality of more crowded moldbase meshes are generated near the cavity.

9. The method as claimed in claim 1, wherein step (c) further comprises:
finding each cavity boundary mesh and each moldbase boundary mesh at the boundary between the cavity mesh system and the moldbase mesh system; and
defining the relationship between each moldbase boundary mesh and each cavity boundary mesh.

10. The method as claimed in claim 1, wherein step (c) further comprises:
ignoring each node of each moldbase boundary mesh in the cavity or at the cavity boundary;
finding the relationship between each remaining node of each moldbase boundary mesh and each remaining node of each cavity boundary mesh.

11. The method as claimed in claim 10, wherein step (c) further comprises:
calculating a relative distance between each node of each cavity boundary mesh and each node of each moldbase boundary mesh;
according to the relative distance, finding the relative relationship between each node of each moldbase boundary mesh and each node of each cavity boundary mesh.

12. The method as claimed in claim 1, wherein step (d) further comprises:
(e) determining a temperature of each node of each moldbase boundary mesh;
(f) according to the relative relationship from step (c) and the temperature of each node of each moldbase boundary mesh, calculating a temperature or a heat flux of each node of each corresponding cavity boundary mesh;
(g) according to the temperature or the heat flux of each node of each cavity boundary mesh, calculating a cooling result for the cavity after a predetermined cooling period;
(h) according to the cooling result and the relative relationship from step (c), calculating the temperature or the heat flux passing from each node of each cavity boundary mesh to the corresponding node of each moldbase boundary mesh;
(i) according to the temperature or the heat flux, calculating a temperature distribution of the moldbase and obtaining a new temperature or a new heat flux for each node of each moldbase boundary mesh;
(j) according to the new temperature or the new heat flux, repeating step (e) to step (i) until a difference obtained between the temperature of each node of each moldbase boundary mesh and the temperature of each node of each corresponding cavity boundary mesh is smaller than a predetermined error value; and
(k) obtaining a temperature distribution as the three-dimensional cooling analysis of the mold.
